(19) United States
(12) Patent Application Publication
(10) Pub. No.: US 2008/0314605 A1
(43) Pub. Date: Dec. 25, 2008

(54) LAND ROLLER

(75) Inventors: Wilfred J. DEGELMAN, Casa Grande, AZ (US); Miles M.E. EVANS, Regina (CA); Donald STEVENSON, Raymore (CA)

Correspondence Address: DAVIS BUJOLD & Daniels, P.L.L.C., 112 PLEASANT STREET, CONCORD, NH, 03301, US

(73) Assignee: Degelman Industries Ltd., Regina (CA)

(21) Appl. No.: 12/142,267

(22) Filed: Jun. 19, 2008

Related U.S. Application Data
(60) Provisional application No. 60/944,987, filed on Jun. 19, 2007.

(51) Int. Cl. A01B 63/16; A01B 73/02

(52) U.S. Cl. 172/311

(57) ABSTRACT

A land roller, and in particular a multiplex land roller including five individual horizontally and longitudinally spaced apart rollers for flattening and leveling agricultural land. The rollers are supported by a pivoting, articulated frame mechanism which allows easy transport of the heavy roller system on ground wheels for purposes of general transportation and ease of implementation into a working arrangement for leveling and rolling land.

### FIELD OF THE INVENTION

The present invention relates to a land roller, and in particular to a multi-plex land roller including five individual horizontally and longitudinally spaced apart rollers for flattening and leveling agricultural land. The rollers are supported by a pivoting, articulated frame mechanism which allows easy transport of the heavy roller system on ground wheels for purposes of general transportation and ease of implementation into a working arrangement for leveling and rolling land.

### BACKGROUND OF THE INVENTION

Land rollers, as they are known, are used for soil compaction and terrain flattening. For example, land rollers are used in the compaction of terrain at building sites for the laying of slab foundations and flattening and compaction of the underlying soil prior to roadway construction. Land rollers are also used by farmers prior to planting and ploughing to develop a consistent surface leveling and uniform soil density to aid in the planting, growing and cultivation of the plantings.

Known rollers are generally coupled with tractors or other earth working equipment and are necessarily of substantial size and weight to accomplish the task of rolling a partially-prepared surface in preparation for further work. By reason of their size, these rollers do not lend themselves to convenient use in close quarters or travel along roadways or maneuvering in anything but a large open area. Generally, short radius turns are not possible and it is difficult to lift such rollers because of the weight of the rollers themselves. The length and width of a tractor and roller contributes to unwieldily roller operation particularly where a surface must be rolled adjacent a building, curb, fence, etc., in which instances care must be taken to avoid damaging such structure by a roller swinging thereagainst throughout the turning axis of the tractor.

It is desirable to have as wide a swath as possible covered by the rollers in each pass for efficiency sake. However, the wider the rollers become, the more unwieldily they become. Accordingly, it is desirable to provide a roller which may track closely behind the tractor during use, and when not in use the rollers themselves may be raised up in their entirety in order to facilitate transportation of the rollers.

### OBJECTS AND SUMMARY OF THE INVENTION

Land rollers are utilized to roll, flatten and level large swaths of land generally for agricultural purposes, for instance for making planting beds for haying, grasses and silage. The more rollers one can pull behind a tractor in a transverse manner, i.e. approximately 90° to direction of travel of the tractor, the more area which can be flattened and/or leveled in a single pass. The issue and difficulties which arise relate to the fact that in order to transport such heavy and wide agricultural rollers to a particular spot, the rollers must be rotated or folded into a more compact arrangement for travel.

In a transport arrangement of an embodiment of the present invention the rollers and the frame are generally carried on a series of ground wheels which raise the frame, and hence the rollers supported thereby out of contact with the ground. Also, in many cases the device must also allow the rollers to be swung via the frame into a parallel position relative to the direction of travel of the tractor in order sufficiently narrow the device to facilitate transport on a road.

An object of the present invention is to provide a multiplex land roller which utilizes five rollers including a center roller, two inner wing rollers and two outer wing rollers where the inner and outer rollers are pivotally connected to a center frame extension and at least partially put into operation via a hydraulic mechanism for spreading apart the frame members between a travel position and a working position.

### BRIEF DESCRIPTION OF THE DRAWINGS

FIG. 1 is a perspective view of the land roller of the present invention;

FIG. 2 is a side elevation view of the land roller in a transport position;

FIG. 3 is a top plan view of the land roller in the transport position;

FIG. 4 is a top plan view of the land roller in the transport position detailing the hydraulic lines and cylinders for actuating various components of the land roller;

FIG. 5 is a side elevation view of the front ground wheel and center roller;

FIG. 6 is a perspective view of the land roller in a field deployed position;

FIG. 7 is a partial top plan view detailing the structure and function of the spreader arms in deploying the wing rollers;

FIG. 8 is a partial top plan view detailing the structure and function of the swing and truss arms used to maintain the deployment of the wing rollers;

FIG. 9 is a front perspective view of the land roller in the field position;

FIG. 10 is rear perspective view of the center and inner rollers in a position between the field position and the transport position; and

FIG. 11 is a perspective view of the inner and outer rollers in the transport position showing the telescoping linkage 45 facilitating axial rotation between the inner and outer rollers.

### DETAILED DESCRIPTION OF THE PREFERRED EMBODIMENTS

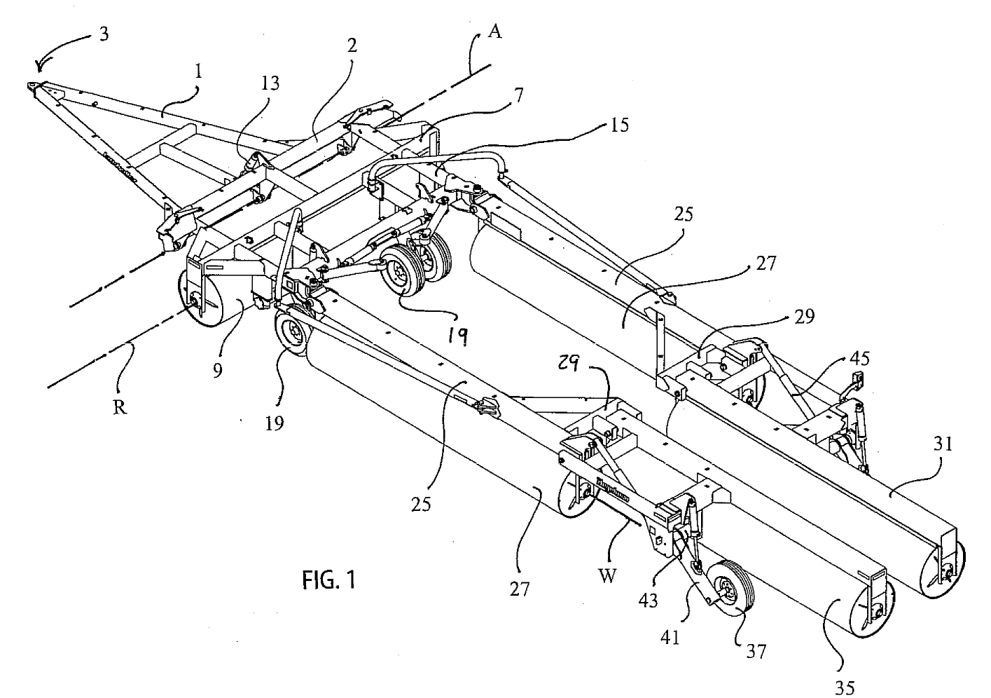

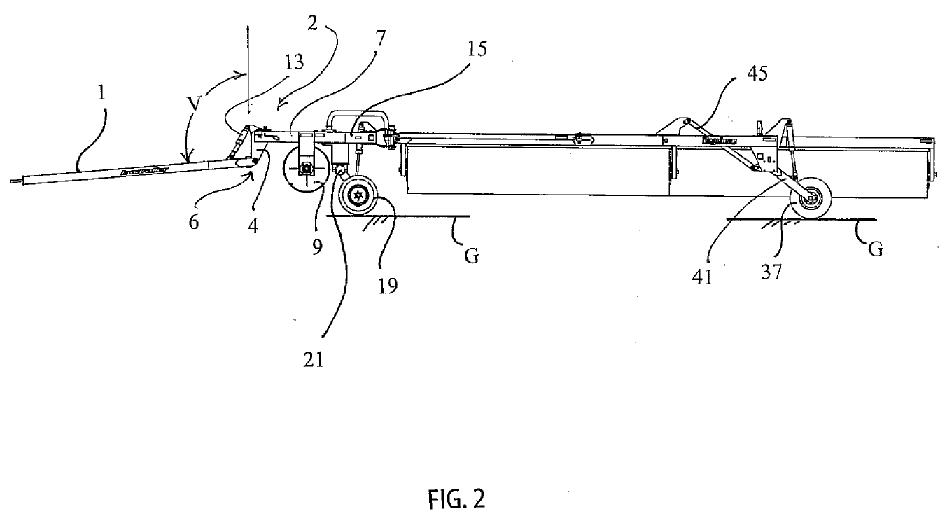

Turning to FIG. 1, the land roller of the present invention includes an A-frame hitch pole 1 having a tractor hitch 3 at a first end for connection with a tractor (not shown). At the base of the A-frame hitch pole 1 is provided a pivotal swing axis A for connection to the center frame 7. The center frame 7 includes a front portion 2, better seen in FIG. 2, which is pivotally connected to the hitch pole 1 along the axis A and extends generally upwards at approximately a 90° angle V therefrom. This angle V may be varied according to the desires of the user via a center frame hydraulic 13 which permits the user to raise and lower the hitch pole 1 so as to level it with a tractor to which the land roller is connected. The front portion 2 of the center frame 7 includes several depending support braces 4 which extend downwards a desired distance at approximately ninety degrees from a fixed connection with a front bar of the center frame 7. The front braces 4 extend to a free end 6 defining the pivotal swing axis A about which the hitch pole 1 and center frame 7 are respectively rotatable.

The support braces 4 in conjunction with the hitch pole 1 define the variable angle V therebetween them, and the center hydraulic 13 extends from a pivot connection on the hitch pole 1 to a second pivot connection on the center frame 7 substantially across, and so as to define, variable angle V. It is by actuation of the center hydraulic 13 that the variable angle V can be controlled by essentially rotating the support braces 4 and inherently the center frame 7 about the swing axis A and thereby adjust the positioning of the center frame 7 and a center roller 9 supported on the center frame 7 relative to the hitch pole 1.

The center frame 7 supports a center roller 9 depending downwardly therefrom along a center rolling axis R which is fixed in regards to the center frame 7, but as explained above, according to the arrangement of the support braces 4, rotates in a parallel manner around the swing axis A. As can be appreciated, the center frame 7 and the center rolling axis R can be adjusted by the center hydraulic 13 to essentially rise up and down by rotating about the front swing axis A, which as explained in further detail below, permits the raising and lowering of the center roller 9 relative to the ground.

As seen in FIGS. 1 and 2, the center frame 7 is further provided with a center frame extension 15 which extends rearwardly of the center frame 7 and supports at least a pair, and generally two pairs, of front ground wheels 19. The ground wheels 19 are rotatable via an associated hydraulic piston about a rocker shaft 21 so that when pressure is provided to the hydraulic piston for the front ground wheels 19 the front ground wheels 19 rotate about the rocker shaft 21 which is attached to the center frame extension 15. FIG. 2 shows the land roller in a transport position with the ground wheels 19 in contact with the ground and having raised the front roller 9 off the ground. As can be appreciated, from the transport position, as the front ground wheels 19 rotated about the rocker shaft 21 out of contact with the ground the center roller 9 is lowered into contact with the ground. On the other hand, the actuation of the ground wheels 19 being rotated about the rocker shaft 21 and brought into contact with the ground raises the center frame extension 15 and hence the center frame 7 as well as the center roller 9 above the ground for purposes of facilitating transport as shown in FIGS. 1, 2.

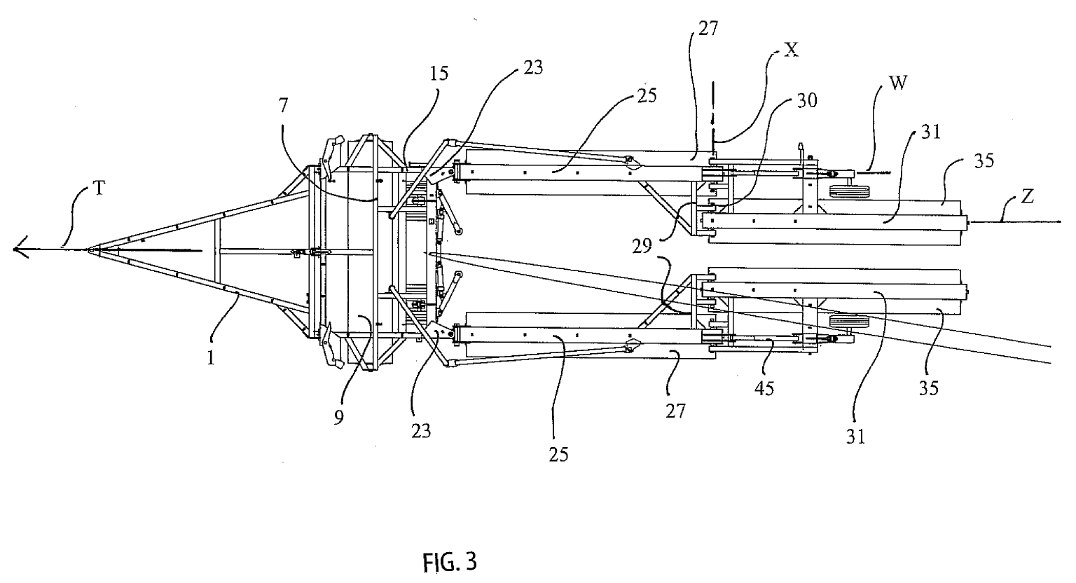

The top plan view of FIG. 3 shows the center frame extension 15 provided with two opposing corner joints 23 to which are pivotally attached a respective left and right inner wing supports 25 extending rearwardly therefrom in the transport position as seen in FIGS. 1-3. Each inner wing support 25 rotates about its respective corner joint 23 on the center frame extension 15 so that the inner wing supports 25 can be articulated from the transport position, where the supports 25 are generally perpendicular to the travel vector T of the land roller, to the field position, where the supports are spread apart into a generally parallel relative position with the center roller 9.

Just like the center frame 7, each inner wing support 25 rotatably supports an inner wing roller 27 thereunder which rotates about an inner wing roller axis W depending a fixed distance from the respective support 25. At a far end of each of the inner wing supports 25 is a perpendicular extension arm 29 pivotally supporting an outer wing support 31. The perpendicular extension arm 29 is fixed relative to the respective inner wing support 25, and has at a point along the extension arm 29 a pivotal connection 30 defined by an axis X radially spaced from and perpendicular to the inner wing roller axis W for supporting the outer wing support 31. Each outer wing support 31 is axially offset from and parallel aligned relative to a transverse plane with the inner wing support 25. The transverse plan being defined as the plane in which the land roller is viewed in FIG. 3 and which is substantially planar and parallel aligned with the ground surface over which the land roller is traveling.

Each outer wing support 31 accordingly supports an outer wing roller 35 depending therefrom which is similarly axially offset from and parallel aligned with the adjacent inner wing roller 27 relative to the transverse plane as seen in FIG. 3. The pivot connection about the axis X by which the outer wing supports 31, and hence the outer wing rollers 35, are connected to the extension arms 29 and aligned substantially horizontally, i.e. parallel, relative to the ground surface. This alignment permits the outer wing supports 31 to rotate up and down about the pivot connection and axis X, i.e. in and out of the page as viewed in FIG. 3. This means that an outer wing roller axis Z does not necessarily have to be parallel aligned with the inner wing roller axis in a vertical plane, the vertical plane being defined as a plane perpendicular to the transverse plane as viewed in FIG. 3 and relative to the ground surface.

This arrangement permits a desired degree of freedom of the outer wing support 31 and outer wing roller 35 relative to the center roller 9, inner wing support 25 and roller 27. This is important because with the great width of this land roller in the field position, e.g. in the range of 60-80 or more feet, there maybe significant elevation and slope differences along the width. The more independent the rollers are from one another, the easier it is for the land roller to maintain the center, inner wing and outer wing rollers in complete contact with the ground to produce the effective soil compaction desired. The same holds true for the substantial length of the land roller in the transport position where the relative independence of the outer wing supports and rollers 31, 35 can permit easier travel of roadways and undulating terrain.

In the travel state or position as shown in FIGS. 1-3 each of the outer wing supports 31 and respective outer wing rollers 35, inner wing supports and rollers 25, 27 and the center roller 9 are directly supported in a manner entirely spaced from the ground surface G by the front ground wheels 9 and a set of rear ground wheels 37. The rear ground wheels 37 are pivotally connected to each outer wing support 31 to raise the outer wing support 31 and depending outer wing roller 35 off the ground when necessary for the transport position as shown. The rear ground wheels 37 are supported on a trailing arm 41 which like the front ground wheels 19 rotates via a hydraulic actuator about a rocking arm 43 to raise and lower the end of the land roller when desired.

Observing FIGS. 1-3 it is to be understood that in order to also simultaneously assist in raising the inner wing support 25 and roller 27 off the ground the rear ground wheel 37 and/or the trailing arm 41 must also be pivotally connected by a linkage to the inner wing support 25. This is done according to a linkage arm 45 pivotally connected from the trailing arm 41 to the inner wing support 25. When it is desired to raise the rollers 27, 35 off the ground, the rotation of the rear ground wheels 37 and the trailing arm 41 about the rocking arm 43 also pushes on the linkage arm 45 to raise the ends of the inner wing supports 25. This linkage arm 45 may be a fixed length arm or even a telescoping arm having relatively movable co-axial portions which slide relative to one another in order to provide play by shortening and lengthening in the linkage arm when the land roller is in the transport position.

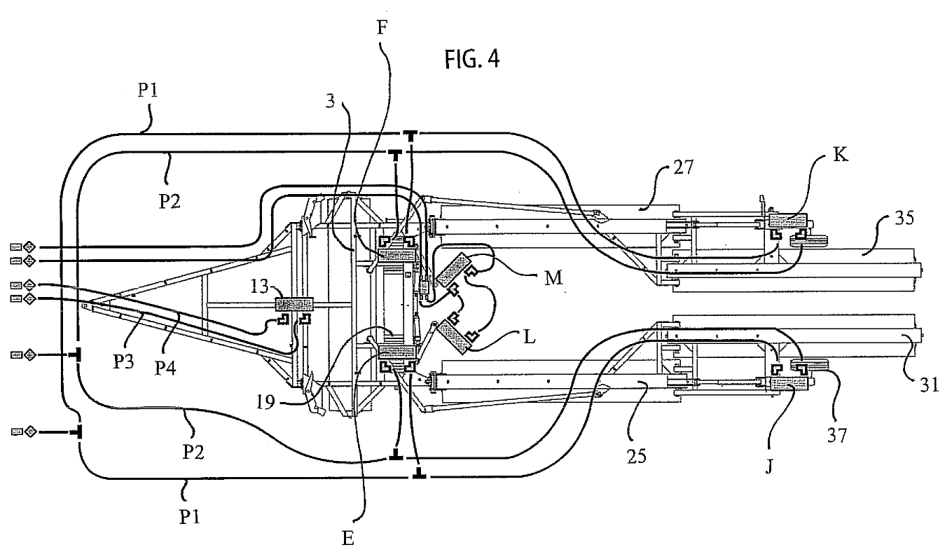

When the land roller must be moved from the field position to the transport position the user actuates the hydraulics system shown in FIG. 4. The hydraulic system substantially simultaneously rotates the front ground wheels 19 about the rocking shaft 21 and rear ground wheels 37 about the rocking arms 43 in order to lift the center frame 7 via hydraulic pressure in lines P1 and P2. Another control, or even the same control, may be used to actuate the center hydraulic 13 via hydraulic pressure in lines P3 and P4 and thus rotate the front of the center frame 3 about the pivotal swing axis A in conjunction with the raising of the inner wing supports 25 and outer wing supports 31. In conjunction with the operation of the center hydraulic 13, the ground wheel hydraulic cylinders E, F and J, K extend and the linkage arms 45 cooperatively assist the entire unit including both the inner and outer wing supports 25, 31 and rollers 27, 35, to lift up in the air and off the ground surface to facilitate transport.

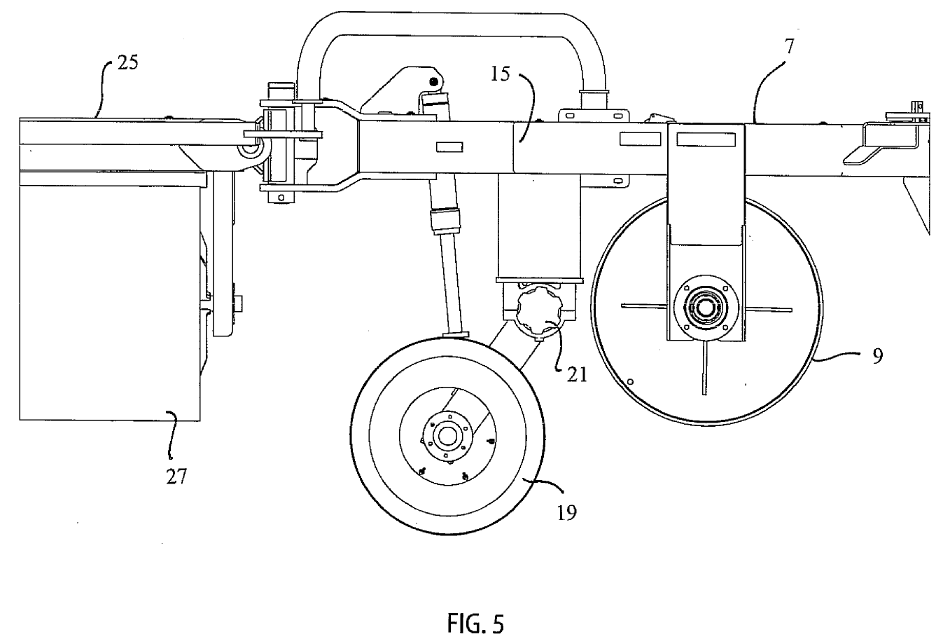

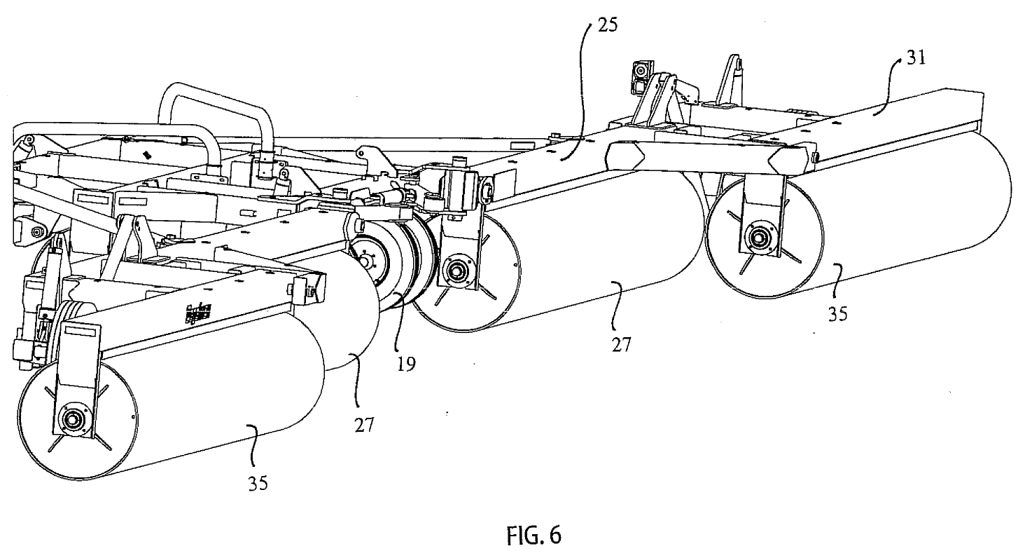

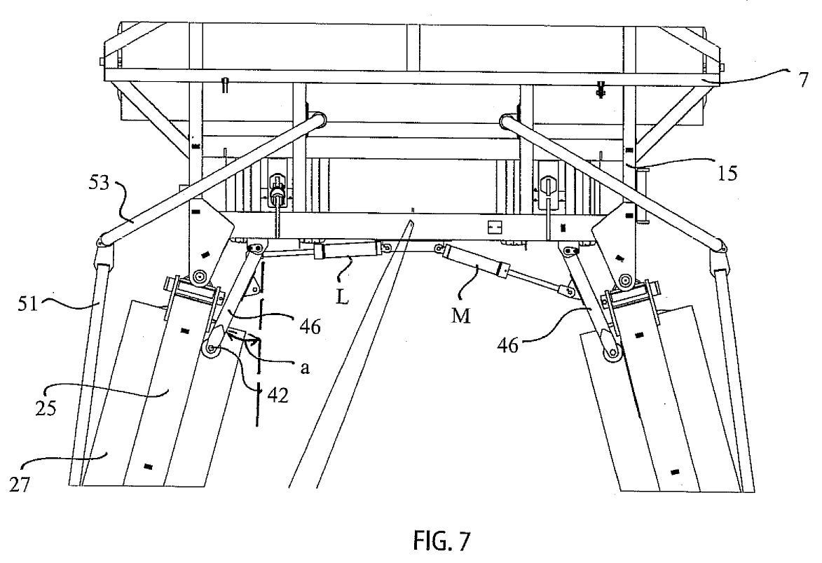

Also, in order to facilitate the movement of the land roller from a transport position as seen in FIG. 5 to a field position as shown in FIG. 6 where the inner and outer wing rollers 27 and 35 respectively are spread apart and parallel with the front center roller 9, a pair of wing spreaders 46 are provided and pivotally supported on the center frame extension 15 as best seen in FIG. 7. The wing spreaders 46 have a free end 42 with a bearing or roller thereon and are hydraulically actuated by hydraulic cylinders L, M which move the wing spreaders 46 outward to engage with the inner wing supports 25 and force them outwards to a limited angle a in the range of about 15° to 30° relative to the longitudinal axis of travel T of the land roller. A hydraulic control operated either alone or in conjunction with the other hydraulic controls operates to supply pressure via lines P5, P6 to the cylinders L, M and hence operate the wing spreaders 46.

In the travel position, the trailing wing supports 25, 31 and rollers 27, 35 are carried over-center, meaning essentially straight back and parallel with the direction of travel of the land roller. Therefore, the wing spreaders 46 provide a boost to the process of moving the device from the travel or transport position to the field position. In order to start a transition from transport to field position, a driver may back up the land roller and at the same time activates the hydraulics cylinders L, M which operate the wing spreader arms 46. The spreader arms 46 rotate outwards about their pivot attachment with the center frame extension 15 and the bearing at the free ends 42 thereof, which provides an initial boost and assist to spread by pushing the inner wing supports 25, and hence the outer wing supports 31, off-center and outward to the limited angle a.

This limited angle a is dependent of course upon the length of the spreader arms 46. Once this limited angle a is surpassed, i.e. when the inner and outer wing supports 35, 31 and rollers 27, 35 are sufficiently off-center, it is relatively easy to complete the deployment of the inner and outer rollers 27 and 35 into the field or working position with all the rollers parallel as the driver continues backing up. Then, once the rollers are parallel with one another and locked into the field position, the operator lower all the rollers 9, 27 and 35 to the ground, incidently raising the ground wheels 19, 37, and backs up the entire land roller. It is also possible to leave the ground wheels 19 and 37 in contact with the ground without lowering the rollers and back up the land roller to also spread the wing supports 25, 31 outward to the limited angle a. The weight and the friction of the rollers 27 and 35 with the ground thus force the land roller to extend to its full width.

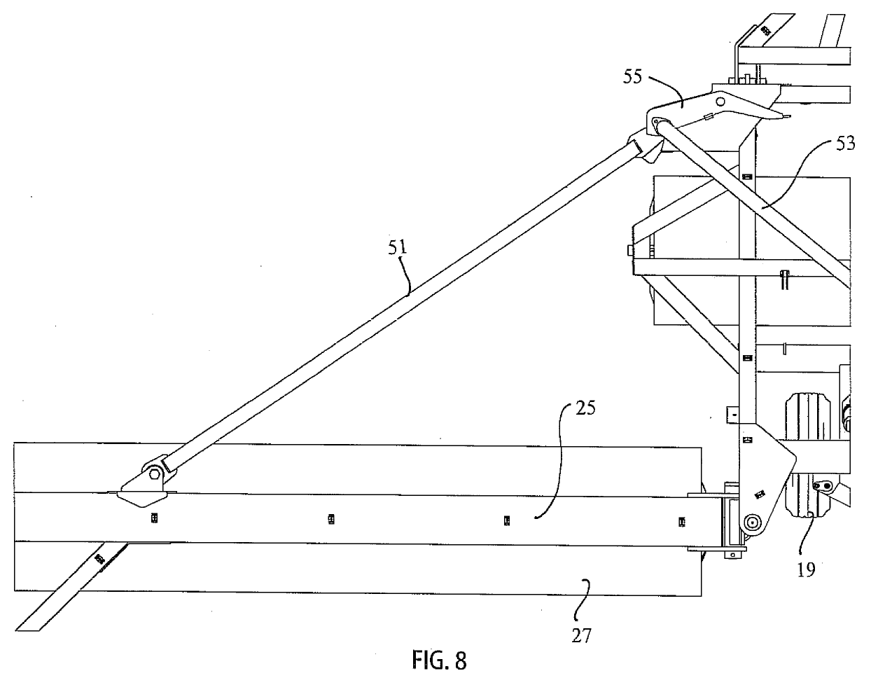

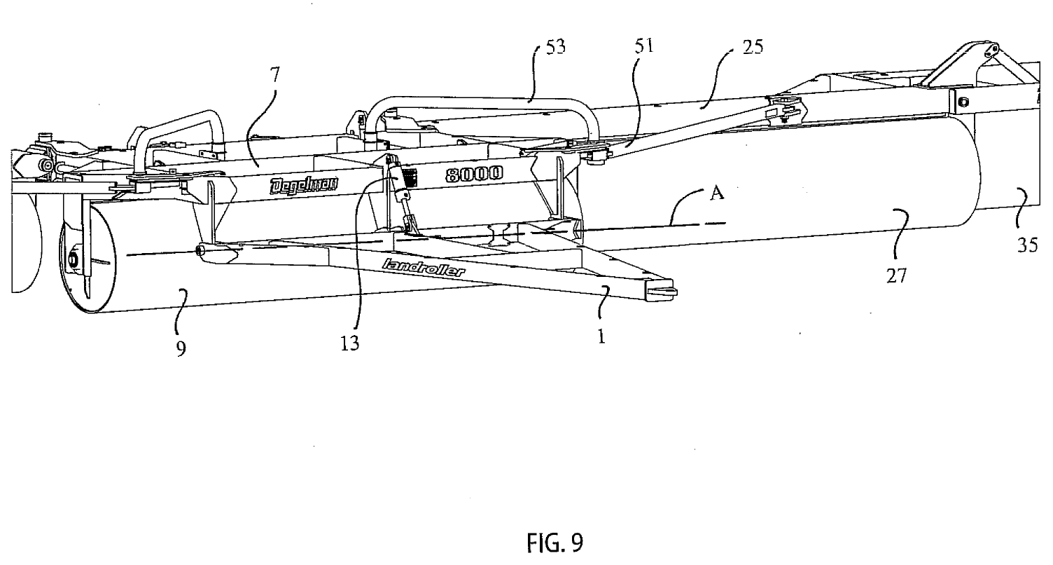

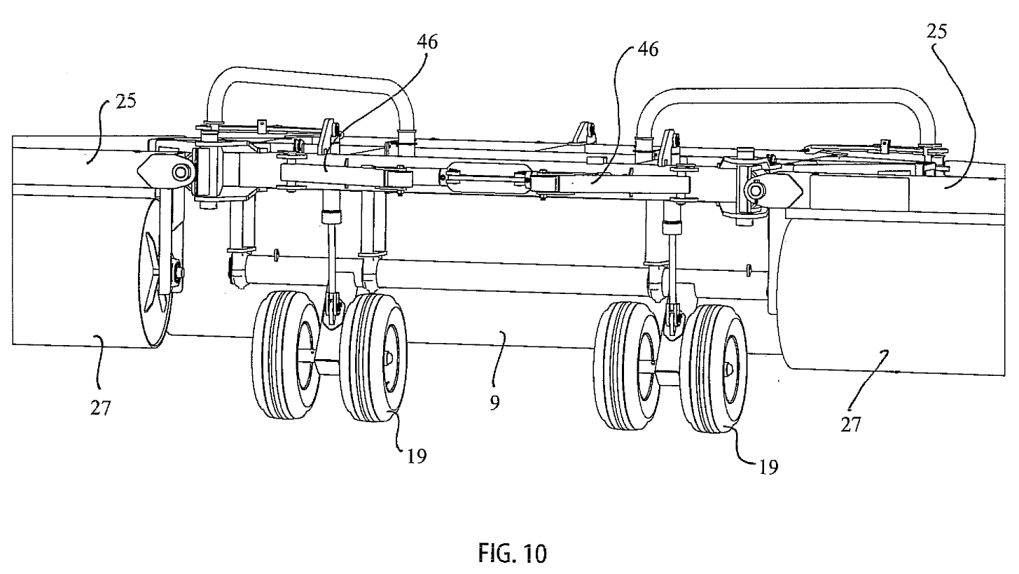

Generally, once the wing supports 25, 31 and rollers 27 and 35 are aligned approximately parallel with center roller 9, the user stops backing up and then fully retracts the transport ground wheels 19, 37 to lower the wing rollers 27, 35 entirely to the ground. A swing and truss arm 51, 53 may be provided between the center frame 7 and the far end of the inner wing support 25 to facilitate the dynamic motion of the wing supports relative to the frame 7 and the tractor. A locking bar 55 may be provided on the center frame 7 to assist in maintaining the swing and truss arm 51, 53 and hence the rollers 27, 35 in the desired field position as seen in FIG. 8. The tractor hydraulics are then set to activate the hydraulic cylinders, namely the center frame hydraulic 13 in FIG. 9, into a “float” position which generally allows the center frame 7 to rotate in a limited manner about the pivotal swing axis A and hence hitch pole 1 during field use to contour more effectively and prevent strain on the land roller in the working position. As seen in FIG. 10 the spreader arms 46 are also returned to an initial stored position so they do not interfere with the dynamic motion of the supports and rollers when returned from the field position to the transport position.

Once the land roller is backed up and lowered into the working position, it is important that the supports 25, 31 and rollers 27, 35 making up the wings of the land roller can flex approximately up to 20° up or down relative to one another while the land roller is pulled forward over the ground. Once the wing supports and wing rollers are in the working field position, it is to be appreciated that besides the swing and truss arms 51, 53, their own dynamic rotation and mass maintain the rollers 27, 35 in a relatively parallel arrangement. Importantly, the center frame hydraulics 13 which may be one or two or more cylinders connecting the A-frame hitch pole to the center frame 7, allows the driver to adjust the relative land roller hitch pole 1 height to match the tractor hitch height again to facilitate the “float” of the land roller across the contours of the ground surface.

In the field or working condition, the land roller has the float position as dictated by the hydraulic controls. The float is based on the drivers ability to push her hydraulic levers forward and the actuated cylinders will collapse where a force or weight is applied to the cylinder piston to a desired point. When she pulls the hydraulic lever backwards the cylinders extend to a desired length and the operator lets go of the hydraulic lever locking the cylinder at the desired length. The float position is when the lever is pushed all the way forward to a position allowing the oil to free flow back and forth and a fixed pressure is not locked, i.e. maintained by the tractor hydraulic valve. In other words, when the land roller is pulled by a tractor in the field, the driver would put this the center frame hydraulic 13 connecting the hitch pole 1 to the center frame 7 in a float position and the A-frame hitch pole 1 will contour as if the rollers did not exist, i.e. the cylinder or roller 9 will have little if any effect on the vertical motion of the hitch pole 1. When the driver finds it necessary to move the machine into the travel or transport condition, she would take that cylinder out of float, and essentially lock the hitch pole 1 to the center frame 7 at a desired angle so that the cylinder can be lifted off the ground via the front ground wheels 19 as previously described.

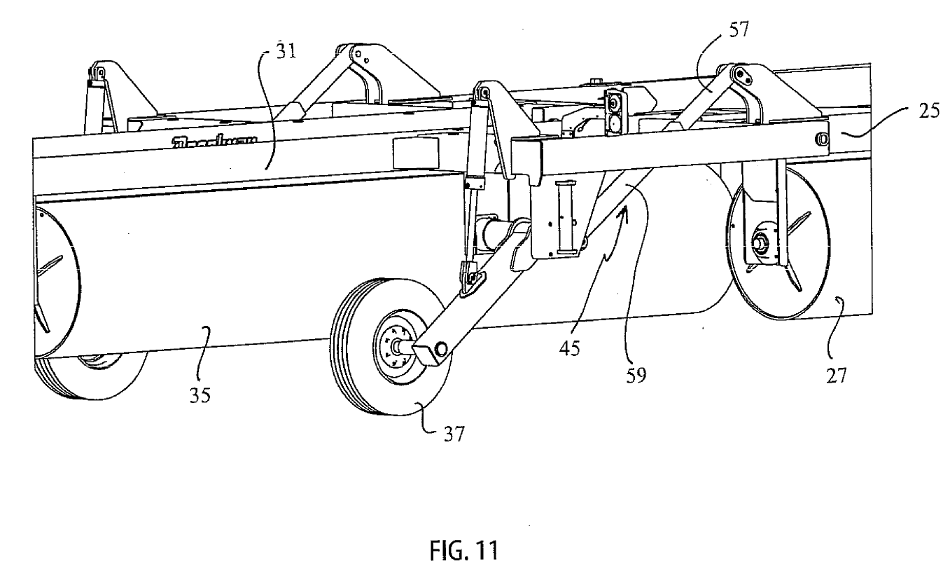

In order to allow independent movement and have some flex at the pivotal connection between the inner and outer supports 25 and 31 so that the land roller can more accurately follow the contours of the topography in either the transport or field position, there must potentially be allowed some play along the linkage arm 45. Observing FIG. 11, this can be addressed by making the arm telescoping with an upper portion 57 and a lower portion 59. Otherwise, a significant angle change between these portions of the land roller could cause substantial damage to the mechanism. In other words, the land roller is better able to contour the ground automatically without dynamic interference where the linkage arms 45 can telescope in and out absorbing any angle change between the inner and outer supports 25, 31 and rollers 27, 35.

Since certain changes may be made in the above described improved pipe support without departing from the spirit and scope of the invention herein involved, it is intended that all of the subject matter of the above description or shown in the accompanying drawings shall be interpreted merely as examples illustrating the inventive concept herein and shall not be construed as limiting the invention.

I/We claim:

1. A land roller for flattening and leveling land comprising:
a front hitch pole for connection with a vehicle;
a center frame supporting a center roller relative to the ground;
a first support arm supporting a first roller and a second support arm supporting a second roller; and
wherein the first and second support arms are each pivotably supported at a first end by the center frame of the land roller.

2. The land roller for flattening and leveling land as set forth in claim 1 further comprising a first pair of ground wheels pivotably connected to the center frame for raising and lowering the center frame relative to a ground surface.

3. The land roller for flattening and leveling land as set forth in claim 2 further comprising a transport position where the first pair of ground wheels raises the center roller, first roller and second roller out of contact with a ground surface and a field position whereby the first pair of ground wheels lowers the center roller, first roller and second roller out of contact with a ground surface in a transport position of the land roller.

4. The land roller for flattening and leveling land as set forth in claim 3 wherein the center frame is pivotably connected to the front hitch pole about a main pivot axis.

5. The land roller for flattening and leveling land as set forth in claim 4 further comprising an extensible and contractable member pivotably connected between the center frame and the front hitch pole for controlling the relative rotation of the center frame about the main pivot axis.

6. The land roller for flattening and leveling land as set forth in claim 5 further comprising a third support arm and a fourth support arm each pivotably connected to one of the first and second support arms, the third support arm supporting a relative third roller and the fourth support arm supporting a relative fourth roller.

7. The land roller for flattening and leveling land as set forth in claim 6 wherein in the field position a longitudinal axis of rotation of each of the center roller, first roller, second roller, third roller and fourth roller is parallel with each adjacent roller.

8. The land roller for flattening and leveling land as set forth in claim 7 wherein in the transport position the longitudinal axis of rotation of the first, second, third and fourth roller is substantially perpendicular to the axis of rotation of the center roller.

9. The land roller for flattening and leveling land as set forth in claim 8 wherein a second ground wheel is pivotally connected with at least one of the second and third support arms and a third ground wheel is pivotally connected with at least one of the second and fourth support arms.

10. A land roller for flattening and leveling land comprising:
a front hitch pole for connection with a vehicle;
a center frame connected to the front hitch pole and supporting a center roller relative to the ground;
a first support arm supporting a first roller and a second support arm supporting a second roller;
a third support arm supporting a third roller and a fourth support arm supporting a fourth roller; and wherein said first and second support arms being each pivotably supported at a first end by the center frame of the land roller, and a second end of said first support arm being pivotally connected to said third support arm and a second end of said second support arm being pivotally connected to said fourth support arm.

11. The land roller for flattening and leveling land as set forth in claim 10 further comprising a first pair of ground wheels pivotably connected to the center frame for raising and lowering the center frame relative to a ground surface.

12. The land roller for flattening and leveling land as set forth in claim 11 further comprising a transport position where the first pair of ground wheels raises the center roller, first roller and second roller out of contact with a ground surface and a field position whereby the first pair of ground wheels lowers the center roller, first roller and second roller out of contact with a ground surface in a transport position of the land roller.

13. The land roller for flattening and leveling land as set forth in claim 12 wherein the center frame is pivotably connected to the front hitch pole about a main pivot axis.

14. The land roller for flattening and leveling land as set forth in claim 13 further comprising an extensible and contractable member pivotably connected between the center frame and the front hitch pole for controlling the relative rotation of the center frame about the main pivot axis.

15. The land roller for flattening and leveling land as set forth in claim 12 wherein in the field position a longitudinal axis of rotation of each of the center roller, first roller, second roller, third roller and fourth roller is parallel with each adjacent roller.

16. The land roller for flattening and leveling land as set forth in claim 15 wherein in the transport position the longitudinal axis of rotation of the first, second, third and fourth roller is substantially perpendicular to the axis of rotation of the center roller.

17. The land roller for flattening and leveling land as set forth in claim 16 further comprising a first and second spreader arms, each spreader arm connected at a first end to the center frame and having a free end for contacting and influencing the respective first and second support arms to assist in the articulation of the land roller between the transport and the field position.

18. A method of articulating a land roller for flattening and leveling land between a transport position and a field position, the method comprising the steps of:
connecting a front hitch pole of the land roller with a vehicle;
connecting a center frame to the front hitch pole and supporting a center roller relative to the ground by the center frame;
providing a first support arm supporting a first roller and a second support arm supporting a second roller;
pivotally attaching a first end of each of the first and second support arms to the center frame of the land roller and a power transfer device to rotate both the first and second support arms and respective first and second rollers about the pivotal attachments to the center frame; and
aligning the first support arm and the second support arms in the transport position so that a longitudinal axis of the first roller and the second roller are substantially perpendicular to a longitudinal axis of the center roller and in the field position aligning the first and second support arms so that the longitudinal axes of the first and second roller are substantially parallel with the longitudinal axis of the center roller.

19. The method of articulating a land roller for flattening and leveling land between a transport position and a field position as set forth in claim 18, the method further comprising the steps of raising the center roller, first roller and second roller off a ground surface in the transport position and lowering the center roller, first roller and second roller to contact the ground surface in the field position.

20. The method of articulating a land roller for flattening and leveling land between a transport position and a field position as set forth in claim 19, the method further comprising the steps of pivotally connecting a third support arm and respective third roller to the first support arm and pivotally connecting a fourth support arm and a respective fourth roller to the second support arm.
